(19) United States
(12) Patent Application Publication
(10) Pub. No.: US 2001/0025267 A1
(43) Pub. Date: Sep. 27, 2001

(54) System and method for facilitating bidding transactions and conducting project management utilizing software metric collection

(76) Inventor: Stephen Janiszewski, Leonia, NJ (US)

Correspondence Address: Loria B. Yeadon, Honeywell International Inc., 101 Columbia Road, Morristown, NJ, 07962, US

(21) Appl. No.: 09/734,793

(22) Filed: Dec. 12, 2000

Related U.S. Application Data
(60) Provisional application No. 60/176,421, filed on Jan. 14, 2000.

(51) Int. Cl. G06F 17/60; G06F 15/16

(52) U.S. Cl. 705/37; 705/26; 709/203

(57) ABSTRACT

A software metric collection method facilitates bidding and project management transactions. The system and method permit a contractor to solicit bids from one or more interested bidders for an open project in an efficient and cost effective manner and to select a suitable bidder based on bid amount and stored software metric data reflecting past performance accrued by each bidder based on past completed projects. The system and method further enable the contractor upon designation of the successful bidder to track and manage the pending project through the collection and analysis of software metrics procured during the undertaking of the project. In this manner, the system and method provide the contractor with competitive pricing from bidders, while ensuring a high level of quality, performance, and timeliness in the resulting product or service where reliability and quality are critical issues for the contractor.

### CROSS REFERENCE TO RELATED APPLICATIONS

This application claims the benefit of U.S. Provisional Application No. 60/176,421, filed on Jan. 12, 2000.

1. Field of the Invention

The present invention relates generally to a method for facilitating bidding transactions, and more particularly to a method for enabling one or more contractors to conduct confidential assignment bidding transactions with at least one bidder preferably via a suitable communications channel.

BACKGROUND OF THE INVENTION

Companies often have software development needs that can be fulfilled by outsourcing projects to third-party software developers to produce customized software item products or components for internal use or for incorporation into products. Typically, the company prepares a software requirement specification enumerating specific requirements or desired software characteristics and features to be embodied by the program or software item. The specification is then posted or distributed to interested software developers. In this manner, the company solicits competitive pricing bids from the software developers. A deadline for bid submission is typically established and the process is usually confidential and secret. Once the deadline lapses, the company refuses any more bids and reviews the timely submitted ones. The contract for the project is typically awarded to the lowest bidder and the winning bidder is identified and announced. The winning bidder proceeds to develop the software item based on the software requirements within the schedule and cost allotted.

It is widely known that software projects are notorious for running over schedule and budget, yet still contain quality problems (i.e. defects, bugs, missing requirements). The above bidding procedure is typically time-consuming, expensive and administratively burdensome for the company to implement and carry out, and the sheer volume of administrative tasks required can easily overwhelm an understaffed company. In addition, the system lacks any safeguards that would assure the quality of the delivered product and the desired on-time delivery commitment on the part of the winning bidder. The procedure further lacks any capability of demonstrating to the company what a particular project should cost and whether or not the bidders' amount is feasible in view of the software requirements specified and in view of the bidder's own software development capabilities and process. Accordingly, where the time, cost, reliability and quality of the delivered software item product or service are of paramount importance, the above bidding system is thoroughly lacking and unsuitable for satisfying the needs of the company or contractor.

For the foregoing reasons, there is a need for a method for enabling one or more contractors to solicit bids from at least one bidder and contract out a job project to a winning bidder via a confidential bidding process conducted over suitable communication channels. There is a further need for a method which ensures the quality and on-time completion or delivery of the outsourced project. There is a further need for a method which further permits the bidders to gauge each of the software requirements or criteria in the specification for purposes of reaching an appropriate bid amount based on its own past performance and efficiency as indicated by historical metrics data or software metrics data collected from past projects, while permitting the contracting company to use the same historical metrics data in a facilitated manner to evaluate each participating bidder, what the assignment should cost, and the bidder's probable time for completion. It would also be desirable for the contractor to supervise and monitor the progress of an outsourced pending project subsequently to the selection of the winning bidder. In this manner, the contractor may be able to readily coordinate one or more outstanding projects which may be related for improved efficiency.

### SUMMARY OF THE INVENTION

The present invention is generally directed to a method for facilitating a bidding transaction between a contractor and a bidder using software metrics collection. The method further provides for the contractor to monitor, track, and manage a project contracted out to a successful bidder during the course of software development. The present invention desirably ensures a high quality and reliable software product delivered in a timely manner at a reasonable cost to the contractor. The method of the present invention may be implemented in a simple, cost effective and efficient manner, and is especially suitable for various commercial transaction uses.

In accordance with an aspect of this invention, a method for conducting a project bidding transaction for a software item to be developed involves communicating electronically over a communication network between a contractor client system, a bidder client system, and a central bidding server system. A database in the central bidding server system stores software metric data gathered from a plurality of bidders. A contractor client system transmits over the network software requirement information identifying the software item to be developed. A bidder client system receives this information and, if the bidder desires to make a bid, sends its bid information to the central bidding server system, including an identifier of the bidder. The central bidding server retrieves the historical metric data associated with that bidder as previously stored and generates a bid record along with the historical metric data information for communication, over the communication network, to the contractor client system, for review prior to selection.

### BRIEF DESCRIPTION OF THE DRAWINGS

FIG. 1 is a system configuration diagram illustrating one aspect of the present invention;

FIG. 2 is a flowchart illustrating a method for facilitating bidding transaction and providing project management;

FIG. 3 is flowchart of a create new account routine showing an aspect of the present invention;

FIG. 4a is a flowchart of a bidding transaction routine showing an aspect of the present invention;

FIG. 4b is a flowchart of a bidder clarification routine showing an aspect of the present invention;

FIG. 5 is a flowchart of a bidder selection routine showing an aspect of the present invention; and

FIG. 6 is a flowchart of a project metric collection routine showing an aspect of the present invention.

### DESCRIPTION OF THE INVENTION AND PREFERRED EMBODIMENTS

The present invention is generally directed to a method for using software metrics collection to facilitate bidding transactions between contractors and bidders for a particular project such as software item development. The method permits the contractor to evaluate each bid amount as well as each participating bidder based on past performance on prior projects completed, as represented in historical metric data. In this manner, the contractor may gauge the efficiency and proficiency of each bidder measured against industry standards or averages for productivity and quality to ensure quality and reliability in the resulting product at a reasonable cost and schedule. The method further enables the contractor to supervise and manage projects delegated to successful bidders after outsourcing in a real-time mode through periodic or continuous collection of software metrics data, thus further ensuring better project management, product quality, product performance, development process, and cost and schedule estimation.

As used herein the term “software metrics” is defined as a reference to quantitative measures of a software item, such as size, effort, defect, and the like, and includes any calculations based on measurements of any or all components of software development. Software metrics provide information that will assist the contractor to focus and evaluate each of the bidding software developers, and choose the appropriate bidder, as well as track the progress of the selected software developer while simultaneously providing motivation and incentive to the software developer. The collection of software metrics further provides the software developer with feedback on its performance and capability, thus assisting in implementing improvements in the software development process and performance. Accordingly, software metrics data provides the contractor and each bidder better control over the software projects and indicates to the observer more about how a particular software developer operates.

A “software item” is defined herein as any software product or partial product (i.e. modules or objects), a software development resource, a software process such as coding or specifying, an event such as a product failure, a person involved in software production or use such as a designer or project manager, an organization such as a data processing department or a software house.

The term “requirements” denotes herein desired characteristics of the software item being developed.

There are two main types of software metrics, process metrics and product metrics. Process metrics are used to measure the characteristics of the development process and development environment, while product metrics are used to measure the characteristics of the software product developed.

Examples of process metrics include resource metrics and personnel experience metrics. Resource metrics may include effort in terms of man-power, computer size, and development cost. Personnel experience metrics may include the number of years that an organization has been using a particular programming language and the number of years of experience that a programmer has on similar projects. Other factors include the use of structured programming techniques, the use of programming tools, the management techniques employed by the organization, and resource availability. Such process metrics can be used to identify process inefficiencies. For example, effort and duration metrics may be used to identify activities or persons that take a disproportionate amount of time and effort.

Examples of product metrics include the size of the program, the productivity of the programmers, the complexity of the program logic, the number of defects uncovered during development, testing, and use, the number of defects present, and the complexity of the data structures. Various combinations of these and others are also considered as product metrics. Such product metrics are typically used during software testing to measure product reliability and defect detection rates. Other factors such as product reliability and product response time can be measured to give an assessment of some aspects of software quality.

The method of the present invention will be concerned mainly with the processing, collection, transmission, storage, and analysis of software metrics concerning primarily size, time, effort, and defect. However, it is understood that the practice of the present invention is not limited to such and that other metrics as contemplated by those of ordinary skill in the arts, may be utilized that are useful in producing or predicting a strong correlation between current and/or past activities to some later result.

Product size includes numbers of lines of source code (SLOC), bytes of object code, function points, number of objects, number of requirements, and the like. A consistent measure of size is the number of lines of code metric (LOC). Once the size of the system has been determined, estimates can be made using productivity metrics concerning the amount of effort required to develop the software item and, subsequently, the amount of time required to complete the system. From these 10 measurements, other metrics (such as cost and risk) may be determined. A line of code is defined as any line of program text that is not a comment or a blank line. This specifically includes all lines containing program headers, declarations, and executable and non-executable statements.

An effort metric is a measure of time expended by each person in completing a project or task. Typically, effort metrics are expressed in person hours.

A defect metric is associated with the number of problems detected in the output from an activity, such as a bug in software or a flaw in design. Defect metrics are useful for measuring product quality, and includes the number found by testing and by customers. Some defect metrics include defects per unit work product, defect classification (i.e., type, severity, and status), leakage rates, cost of quality, and the like.

Effort, duration, and quality metrics are typically normalized with respect to product size to compare different software items. For example, a measure of productivity can be attained by dividing effort by size that can be useful in comparing different software items. Accordingly, software metrics as used in the present invention include any information or data that provides the contractor with an indication of a bidder's performance, productivity, and estimated value of the work to be performed in a fairly predictable and accurate manner for realizing reduced schedule and development cost, and better quality, performance and project tracking.

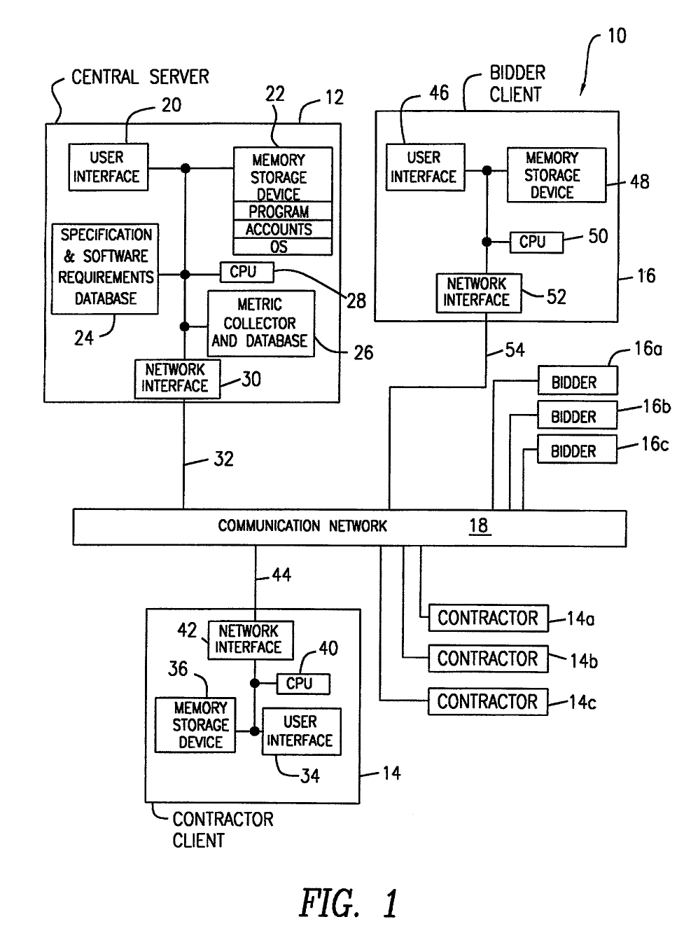

FIG. 1 depicts a system in which the present invention may be utilized. In a bidding transaction and software metrics collection system (10) of the present embodiment, a central bidding server 12, a plurality of contractor client systems 14, 14a, 14b, and 14c, and a plurality of bidder client systems 16, 16a, 16b, and 16c are linked via a communication network 18. The central bidding server 12 conducts collection, management, transmission and storage of bid information and software metrics data between the contractor clients 14, 14a, 14b, and 14c, and the bidder clients 16, 16a, 16b, and 16c. The communication network 18 may represent any system capable of providing the necessary communication and includes, for example, a local or wide area network such as for example ethernet, token ring, or alternatively a telephone system, either private or public, the Internet, the world wide web, the information highway, or any arbitrary differently wired or wireless network.

Each of the systems 12-16c includes a typical user interface 20, 34, or 46, respectively, for input/output and can include a conventional keyboard, display, and other conventional devices. Within each of the systems, the user interface 20, 34, or 46 is coupled to a communication network interface 30, 42, or 52, respectively, which in turn is connected to communication network 18 via a communication channel 32, 44, or 54, respectively. Both the user interface 20, 34, 46 and network interface 30, 42, 52 are also connected in each system to a central processing unit 28, 40, or 50, respectively. Each system 12-16c includes a memory storage device 22, 36, or 48, respectively, which can further be broken down into a program partition, a data partition, and an operating system partition.

In each system the CPU 28, 40 or 50, respectively, represents a source of intelligence when executing instructions from the memory storage device 22, 36, or 48, respectively, so that appropriate input/output operations via the user interface 20, 34, 46, respectively, and the network interface 30, 42, 52, respectively, take place as is conventional in the art.

The central bidding server 12 is a device configured for facilitating bidding transactions between the contractor and bidder clients 14 and 16, transmitting software metrics data therebetween, and conducting software metrics collection from participating bidder clients 16. The central server 12 further includes a software requirement and specification database storage device 24 and a metric collector and database storage device 26. The storage devices 22, 24 and 26 of the central server 12 must be capable of storing a large quantity of data files. The storage devices 22, 24, and 26 may include a magnetic disk, an optical disk, an optical magnetic disk, a semiconductor memory, and the like.

The software requirement and specification database 24 is configured to store and retrieve work or project specification information provided by the contractor clients 14-14C for displaying and viewing by the bidding clients 16-16C. Work specification information may include software requirements for detailing the specific characteristics that the final software item product must contain. The metric collector and database 26 is configured to store and retrieve information concerning software metrics that are processed, transmitted, and recorded from the bidding clients 16-16C beforehand.

The communication channel 32 may include, for example, a telephone circuit, a coaxial cable, a fiber optic cable, and the like for transmitting the information. The communication channel 32 is preferably a cable capable of transmitting a large quantity of data at high speed. If in this case, data are sent/received between the central server 12 and the communication network 18 by using a wireless communication circuit, a wireless communication circuit interface is provided instead of the communication cable 32.

In order to efficiently furnish the software requirement specification information stored in the storage device simultaneously to a large number of other systems and accept the bidding information from bidding clients, it is desirable to use a computer of high speed and large capacity, a work station, or a personal computer as the central server 12 which can supply the computing power required and handle the user traffic.

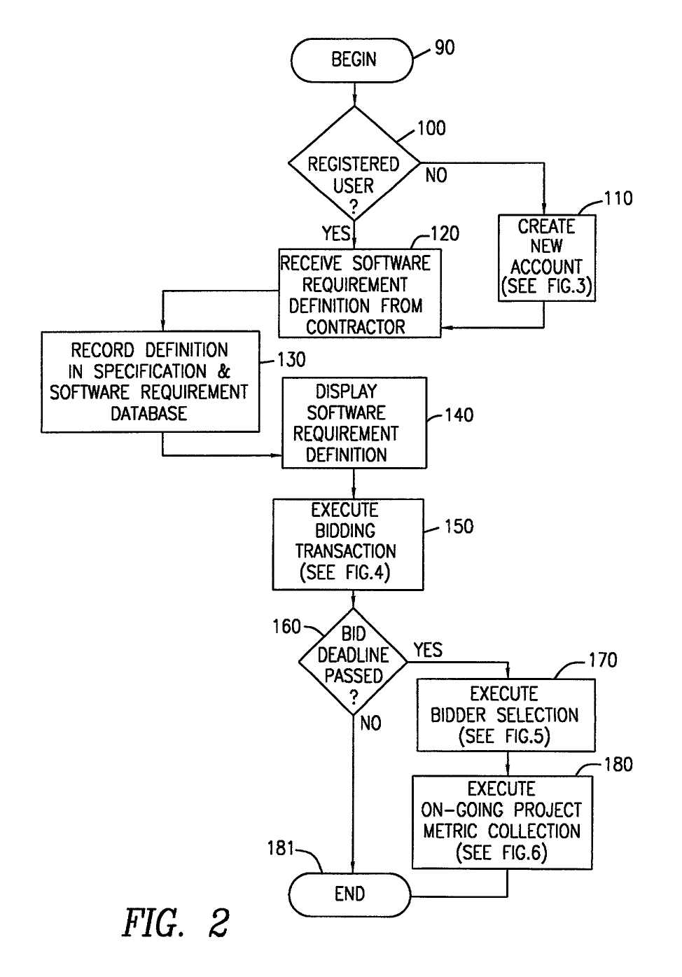

The operation of the preferred embodiment is illustrated in FIGS. 2-6. FIG. 2 is a flowchart illustrating the overall flow of steps for a preferred method for facilitating bidding transactions and providing project management according to the present invention. For example, and not by way of limitation, a bidding transaction may be conducted by a company or institution involved in telecommunications, finance, medical equipment, or aerospace products, where quality and reliability of software items is of paramount importance, to solicit bids and the corresponding historical metrics data from software developers in producing a software item with specific software requirements. Of course, a software item is just one example of a product for which a contractor may purchase. It will be apparent from this description that the method of the present invention may be used to acquire any product or service by the contractor via a bidding transaction.

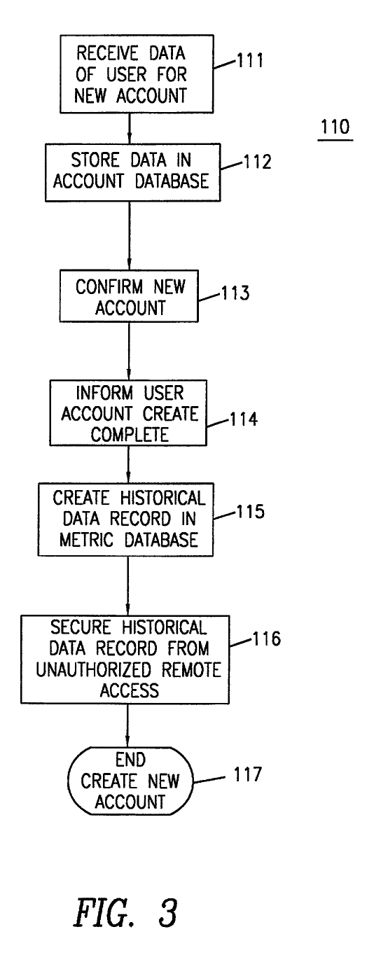

To begin a bidding transaction, a user who may be a contractor or bidder, accesses the central bidding server 12 in step 90 to initiate the method of the present invention. In decisional step 100, the central bidding server 12 inquires whether the user is a registered user. Typically, this step is carried out where the central bidding server 12 is provided with a password subroutine or some other security measure which allows the central bidding server 12 to identify a registered user as is conventional in the art. If the user is not a registered user, then the central bidding server 12 initiates a create new account routine in step 110. The creation of a new account is generally indicated in step 110 in FIG. 2, and detailed in steps 111-116 in FIG. 3. Once the create new account routine 110 is initiated, the user inputs the name and contact information of the individual or company, vital company information such as staff size, experience, and the like and indicates whether the user is a contractor or bidder. The user then enters step 111 of FIG. 3, to send the requested information to the central bidding server 12.

Upon receiving the new account information or data, the server 12 verifies the data, and enters step 112 to store the data in the account database of the storage device 22 (see FIG. 1). After successful verification, in step 113 the central server 12 confirms the new account, and in step 114 informs the user that the account is created, and requests confirmation. Upon receipt of confirmation, in step 115 the central server 12 next creates a historical data record in the metric database 26 (see FIG. 1) in preparation for receiving software metrics data from the user. Next, in step 116 historical data record is then secured in the database 26 to ensure confidentiality of the record. At this point only the owner of the record may view the confidential data. The new account creation process is ended in step 117.

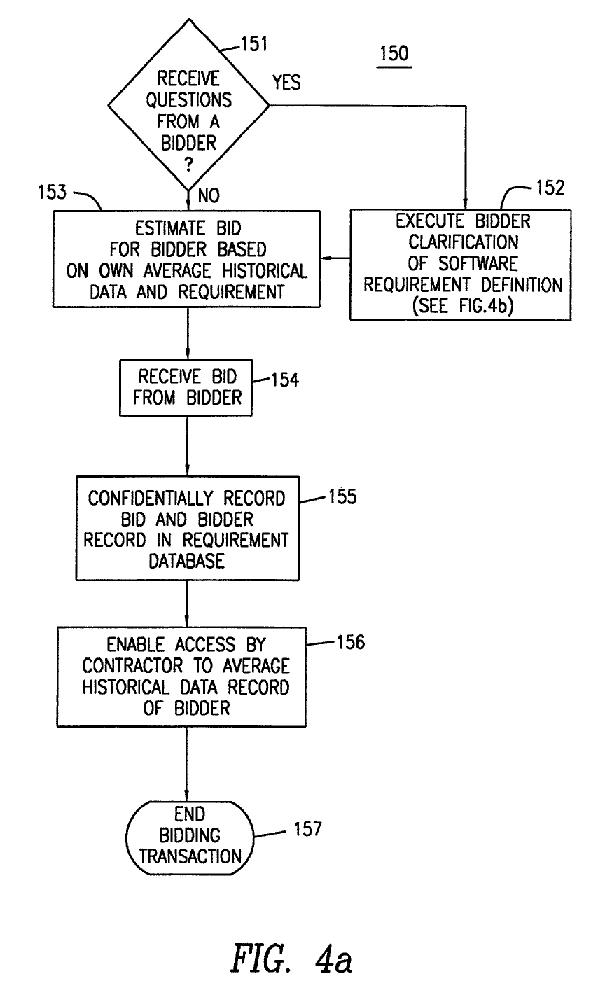

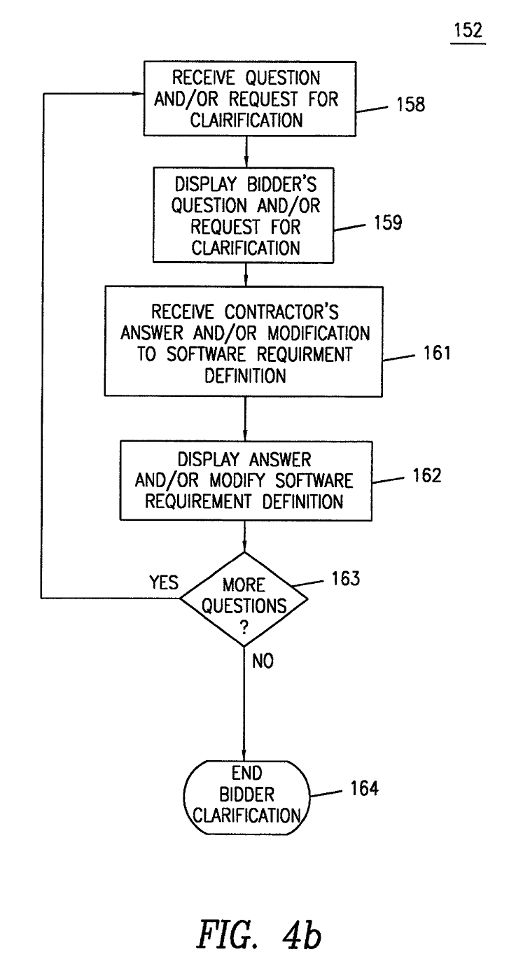

In step 120 (see FIG. 2), the central server 12 receives a software requirement definition from a contractor user for listing the characteristics the final software product should possess. Other information may include the deadline for submitting bids, proposed delivery date, and other specifications. The central server 12 in step 130, records the received requirement definition in the software requirement and specification database 24 (see FIG. 1). In step 140, the recorded requirement definition is then displayed for interested bidder users via a simple listing or a search engine. If the bidder user desires to submit a bid for the project specified in the displayed requirement definition, the bidder user causes the central server 12 to initiate a bidding transaction routine which is generally indicated by step 150 in FIG. 2 and detailed in steps 151-157 in FIG. 4a, as described below.

In query step 151, the central server 12 queries the bidder user to determine if the user wishes to submit a question or request for clarification of definition to the contractor user posting the definition. If the answer is no, the central server 12 proceeds to step 153, which will be described below. If the answer is yes, the central server 12 executes a bidder clarification routine, which is generally indicated by step 152 in FIG. 4a, and detailed in steps 158-163 in FIG. 4b. The bidder user proceeds to submit the question to the central server 12.

In step 158 (see FIG. 4b), the central server 12 receives the question posed by the bidder user. The central server 12 proceeds to step 159, where the question is displayed for the contractor user to view. In step 161, the central sever 12 receives the contractor's answer to the displayed question and/or a command to add/modify the requirement definition. The central server 12 proceeds to step 162 where the answer is displayed to the bidder user and/or the requirement definitions is modified to clarify any uncertainties. In step 163, the central server 12 queries the bidder user to determine if there are additional questions the bidder user wishes to submit. If the answer is yes, the bidder clarification routine is repeated beginning at step 158. If the answer is no, the bidder clarification routine ends in step 164.

The central server 12 proceeds to step 153 in FIG. 4a. In step 153, the central server 12 queries the metric database 26 for the bidder user's historical data record. The central server 12 analyses the data contained in the record and the requirement definition to estimate the bid amount for the project. The bidder user may choose to use the estimated bid amount or another bid amount to be determined by the bidder user. In step 154, the central server 12 receives the bid from the bidder user. The central server 12 records the bid amount in the requirement database 24 (see FIG. 1) and secures the bid amount to ensure confidentiality for the bidder user, step 155. In step 156, the central server 12 enables access of the bidder user's historical data record by the contractor user. However, the contractor user can only view the average historical metrics data of the bidder user rather than specific event metrics data. Step 157 ends the bidding transaction process.

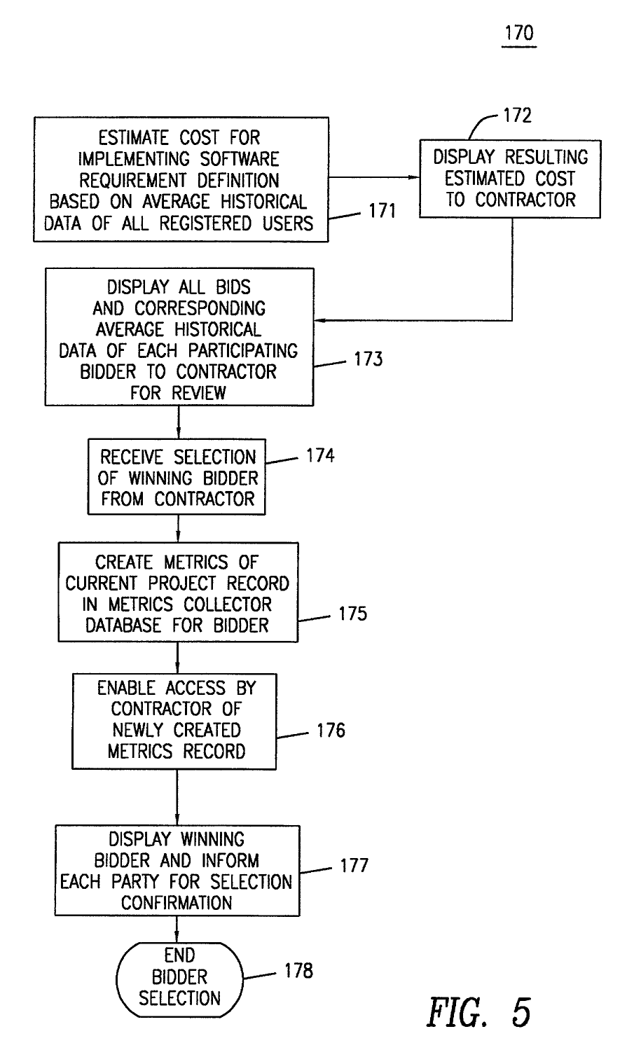

The central server 12 proceeds to query step 160 (see FIG. 2) where it determines if the bid deadline has passed. If the answer is no, the central server 12 proceeds to step 190 where the overall process ends. If the answer is yes, the central server 12 initiates the bidder selection routine which is generally indicated by step 170 in FIG. 2 and detailed in steps 171-178 in FIG. 5.

To start the selection of the winning bidder, in step 170 (see FIG. 2) the contractor user indicates to the central server 12 that it is ready to make a selection. In step 171 (see FIG. 5), the contractor user may execute a cost estimate analysis based on the average historical data record of all registered users and the software requirement definition. This analysis provides some guide as to what the posted project should cost the contractor user. Once the contractor completes the review of the cost estimate, in step 173, the central server 12 displays the identities of all the participating bidder users, and their respective bids. The contractor user may also view the average historical metrics data of each participating bidder user.

When the contractor is prepared to make a selection, the contractor user transmits to the central server 12 the selection of the winning bidder or contracting party. In step 174, the central server 12 receives the selection of the winning bidder.

The central server 12 proceeds to step 175 for creating a current project metrics record in the metric collector database 26 for storing metrics during the course of the software item development process. In step 176, the central server 12 enables access of the current project metrics record by the contractor user to view the metrics for tracking the progress of the software item development. In step 177, the winning bidder is displayed to the contractor and all the participating bidders. Step 178 end the bidder selection process.

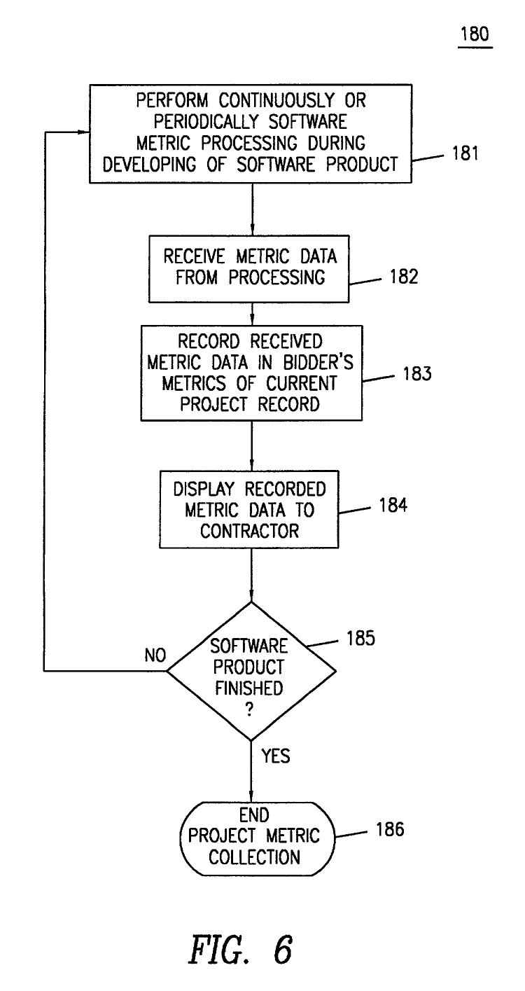

After the winning bidder is selected, an on-going project metric collection routine is initiated which is indicated generally as step 180 in FIG. 2, and detailed in steps 181-186 in FIG. 6. In step 181, during the development of the software item, software metrics are processed and collected from the winning bidder on a continuous or periodic basis. The collected software metrics may include time metrics, quality metrics, defect metrics, size metrics, effort metrics and the like, which may be freely accessed by the contractor for viewing and analysis. The processing may be performed locally by the central server 12 or remotely at the bidder's client computer using commercially available metric tools. Commercial metrics tools are available for measuring code size, complexity, and other metrics in many programming languages. Commercial problem tracking tools are also available which facilitate counting defects and tracking their status. The central server 12 may further utilize simple tracking forms, scripts, and web-based reporting tools to reduce the overhead of collecting and reporting data from the winning bidder. In addition, the use of spreadsheets and charts to track and report on the accumulated software metrics data at regular intervals may also be incorporated.

In step 182 (See FIG. 6), central server 12 receives the metrics data, followed by step 183 for recording the received metrics data in the metrics of current project record in the metrics collector database. Next, in step 184 the collected and recorded metrics data is displayed or uploaded to the contractor client computer for real-time data viewing and analysis.

The process proceeds to decisional step 185 to determine whether the project is completed. If the answer is no, the process returns to step 181 to repeat the metric collection processing. If the answer is yes, the project metric collection process ends in step 186, whereby the software metrics data collected in the current project metrics record is incorporated into the bidder's historical metrics data record. At this step, the winning bidder has delivered the final software item product to the contractor. The contractor may perform extensive testing to ensure compliance with the requirement definition, prior to formal acceptance. The contractor further has the option of providing feedback on the quality and reliability of the delivered software item product or any other comment on the software item development process. The feedback is recorded by the central server 12 with the bidder's historical metrics record for viewing by future contractors. This ends the overall flow of the method of the present invention in step 181 in FIG. 2.

Although various embodiments of the invention have been shown and described, they are not meant to be limiting, but merely as illustrating the presently preferred embodiment. Those of skill in the art may recognize various modifications to these embodiments, which modifications are meant to be covered by the spirit and scope of the appended claims.

What is claimed is:

1. A method for electronically conducting over a communication network a project bidding transaction for a software item to be developed, said method comprising the steps of:
transmitting from a contractor client system over the communication network software requirements definition identifying the software item to be developed;
controlling a bidder client system connected to the communication network to display the software requirements definition identifying the desired software item;
sending bid information along with an identifier of a bidder of the software item project from the bidder client system over the communication network to a connected central bidding server system;
retrieving at the central bidding server system historical metric data previously collected and stored for the bidder identified by the identifier in the bid information received at the central bidding server system;
generating by the central bidding server system a bid record along with historical metric data information; and
communicating said bid record and historical metric data information over the communication network to the contractor client system for review prior to selection and award.

2. The method in accordance with claim 1, further comprising the steps of:
determining by the central bidding server system whether a bidder wishing to bid is a registered user.

3. The method in accordance with claim 2, further comprising, if the bidder wishing to bid is not a registered user, creating a new account by the central bidding server system for that bidder.

4. The method in accordance with claim 3, further comprising the steps of:
determining by the central bidding server whether a bidding period has expired;
executing a bidder selection process, if the bidding period has expired and communicating from the central bidding server system over the communication network to the contractor client system and to the bidder client system identification of the award of the bid; and
subsequent to the awarding of a bid, executing by the central bidding server system an ongoing project metric data collection for monitoring the successful bidder's performance over periodic measuring intervals.

5. The method in accordance with claim 3, wherein the step of creating a new account by the central bidding server system includes the steps of:
receiving personal data associated with an unregistered bidder;
storing in an account database in the central bidding server system said personal data;
confirming said new account and said personal data with the bidder client system of the unregistered bidder and informing the previous unregistered bidder of its new account and registration; and
creating at the central bidding server system a historical metrics data record associated with the new account in a software metrics database.

6. The method in accordance with claim 4, wherein said step of executing a bidding transaction further includes the steps of:
determining if a bidder has questions about the software requirements definition;
clarifying to that bidder, if necessary, the software requirements definition;
estimating a bid for that bidder based on that bidder's historical metrics data record and said software requirements definition;
receiving over the communication network at the central bidding server system an actual bid from that bidder; and
recording said actual bid associated with that bidder and said software requirements definition in a database in the central bidding server system for the subsequent access, over the communication network, by the contractor client system.

7. The method in accordance with claim 6, wherein said step of clarifying to that bidder the software requirements definition further comprises the steps of:
receiving questions from the bidder;
displaying the questions at the contractor client system; and
communicating answers and, if required, modifications of the software requirements definition from the contractor client system to that bidder.

8. The method in accordance with claim 4, wherein said step of executing a bidder selection process further comprises the steps of:
estimating the cost of implementing the software requirements definition for an associated contractor based on an average historical metrics data record of all registered bidders, as stored in the central bidding server system, and the corresponding software requirements definition;
communicating to the contractor client system over the communication network all timely submitted bids and corresponding bidders' historical metrics data individually;
receiving from the contractor client system a selection of the successful bidder; and
creating a current project metrics data record associated with the successful bidder in the metrics collection database in the central bidding server system.

9. The method in accordance with claim 4, wherein said step of executing an ongoing project metrics data collection further includes the steps of:
performing selective periodic or continuous collection of software metrics data from developing software via a metrics processing tool;
recording the collected software metrics data in a current project metrics data record for updating in a metrics collection database in the central bidding server system; and
communicating the updated current project metrics data record to the contractor client system for display to the associated contractor.

10. Apparatus for electronically conducting over a communication network a project bidding transaction for a software item to be developed, said apparatus comprising:
a contractor client system connected to said communication network, software requirement information identifying the software item to be developed being transmitted from said contractor client system over said communication network;
a bidder client system connected to said communication network and including means for displaying the software requirement information transmitted over said communication network from said contractor client system; and a
central bidding server including a software requirement and specification data base, means for storing historical metric data, and means for generating a bid record along with historical metric data information, said generated bid record along with said historical metric data information being transmitted over said communication network to said contractor client system.

11. The apparatus in accordance with claim 10 wherein said central bidder server also includes means for storing metric data collected over said communication network for monitoring a successful bidder's performance over periodic measuring periods.

12. The apparatus in accordance with claim 10 wherein said central server further includes an account database for storing personal data identifying a bidder client system.

13. The apparatus in accordance with claim 10 wherein a plurality of contractor client systems and a plurality of bidder client systems are connected to said communication network.
